(19) United States
(12) Patent Application Publication
(10) Pub. No.: US 2018/0330306 A1
(43) Pub. Date: Nov. 15, 2018

(54) Activities of Daily Work Monitoring and Reporting System

(71) Applicant: Algorithmic Intuition Inc., San Jose, CA (US)

(72) Inventors: Kevin A. Shaw, Millbrae, CA (US); Dan W. Brown, San Jose, CA (US)

(21) Appl. No.: 15/977,914

(22) Filed: May 11, 2018

Related U.S. Application Data
(60) Provisional application No. 62/590,140, filed on Nov. 22, 2017.
(60) Provisional application No. 62/578,331, filed on Oct. 27, 2017.
(60) Provisional application No. 62/505,784, filed on May 12, 2017.

(51) Int. Cl. G06Q 10/06; G06K 19/077; H04W 4/029

(52) U.S. Cl. CPC G06Q 10/063114; H04W 4/029; G06K 19/07762

(57) ABSTRACT

A user-wearable electronic device includes a housing configured to be worn or embedded in a device worn by an employee, one or more sensors disposed in the housing, including a first sensor to sense motion of the employee and produce raw activities of daily work (ADW) data. One or more processors in the electronic device or an intermediary device generate, for time periods in a sequence of successive time periods, ADW identification information by processing the raw ADW data using one or more neural networks pre-trained to recognize a predefined set of ADWs. Each pre-trained neural network includes a plurality of neural network layers, including at least one layer that includes a recurrent neural network. Reports that include ADW information corresponding to the generated ADW identification information for one or more time periods in the sequence of time periods are transmitted to a monitoring system.

### RELATED APPLICATIONS

This application claims priority to U.S. Provisional Patent Application 62/578,331, filed Oct. 27, 2017, U.S. Provisional Patent Application 62/590,140, filed Nov. 22, 2017, and U.S. Provisional Patent Application 62/505,784, filed May 12, 2017, each of which is hereby incorporated by reference in its entirety.

### TECHNICAL FIELD

This relates generally to workplace productivity monitoring devices, including but not limited to wearable electronic productivity tracking devices that monitor and report activities of daily work.

### BACKGROUND

Activities of daily work (ADW) are routine activities that employees tend to do while working, and an employee's productivity in the workplace can be evaluated by keeping track of the employee's ADWs. The level of productivity an employee may exhibit with regard to certain job-specific tasks can be determined by monitoring the ADWs the employee performs over a given period of time. In addition to monitoring productivity on an individual employee basis, business owners and employers have an interest in performing worksite-by-worksite comparisons. For example, when one or more stores or factories fall below expected performance levels when compared to others, business owners have an interest in determining to what extent the underperformance is due to lower than expected employee productivity, and even to what extent an employee in his or her individual capacity may be affecting those outcomes.

Conventional ADW monitoring systems can be burdensome and expensive, requiring the use of cameras, video monitoring systems, tracking infrastructure, and high capacity network connectivity. Further, conventional ADW monitoring systems can be inaccurate due to wide ranges of motions associated with each ADW, which vary from employee to employee. Additionally, conventional ADW monitoring systems can lack the flexibility and mobility required for tracking an employee in multiple locations around a worksite, due to rigid vision systems that are limited in terms of lighting and field of view. Camera-based ADW monitoring systems can also be manipulated by perceptive employees who discover shielded areas in which to take unauthorized breaks.

### SUMMARY

Accordingly, there is a need for ADW monitoring and reporting systems with improved monitoring methods and more portable and self-contained devices. Such methods and devices optionally complement or replace conventional methods and devices for monitoring and reporting ADWs. Such methods provide more accurate ADW classifications by using pre-trained neural networks to interpret raw data, and such devices eliminate the need to install multiple sensing components by being self-contained in a wearable form factor, thereby creating more accurate results with less burdensome hardware. The aforementioned deficiencies and other problems associated with ADW monitoring systems are reduced or eliminated by the disclosed ADW monitoring and reporting systems.

In accordance with some embodiments, a user-wearable electronic device includes a housing configured to be worn by or embedded in a device worn by an employee; one or more sensors disposed in the housing, including a first sensor to sense motion of the employee and produce raw ADW data. The device further includes one or more processors, disposed in the housing and coupled to the one or more sensors, and configured to generate, for each time period in a sequence of successive time periods, ADW identification information for the time period by processing the raw ADW data produced by the first sensor using one or more neural networks pre-trained to recognize a predefined set of ADWs. In some embodiments, at least one of the pre-trained neural networks includes a plurality of neural network layers, at least one layer of the plurality of neural network layers comprising a recurrent neural network, wherein an output of the one or more neural networks for each time period corresponds to the generated ADW identification information for the time period. In some embodiments, each pre-trained neural network includes a plurality of neural network layers, at least one layer of the plurality of neural network layers comprising a recurrent neural network.

The device also includes a transmitter, disposed in the housing and coupled to at least one processor of the one or more processors, to transmit one or more reports corresponding to the employee, wherein a respective report for the employee includes ADW information corresponding to the generated ADW identification information for one or more time periods in the sequence of time periods.

In some other embodiments, obtaining raw ADW data corresponding to an employee and processing the raw ADW data to produce ADW identification information for one or more time periods in a sequence of successive time period is distributed over two or more devices, at least one of which processes the raw ADW data, or related ADW information, using one or more neural networks pre-trained to recognize a predefined set of ADWs. For example, in some embodiments, a user-wearable electronic device includes a housing configured to be worn by or embedded in a device worn by an employee; one or more sensors disposed in the housing, including a first sensor to sense motion of the employee and produce raw ADW data corresponding to the employee. The device also includes a transmitter, optionally disposed in the housing, to transmit the ADW data or ADW information generated from the ADW data, to a monitoring system or to an intermediate device at which the ADW data or ADW information is further processed to generate, for each time period in a sequence of successive time periods, ADW identification information for the time period by processing the raw ADW data produced by the first sensor or ADW information generated from the ADW data, using one or more neural networks pre-trained to recognize a predefined set of ADWs. In some of these embodiments, at least one of the pre-trained neural networks includes a plurality of neural network layers, at least one layer of the plurality of neural network layers comprising a recurrent neural network, wherein an output of the one or more neural networks for each time period corresponds to the generated ADW identification information for the time period. In some of these embodiments, each of the pre-trained neural networks includes a plurality of neural network layers, at least one layer of the plurality of neural network layers comprising a recurrent neural network.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a context diagram illustrating a user-wearable electronic device, configured to perform ADW monitoring and reporting, in accordance with some embodiments.

FIG. 1B is a context diagram illustrating an example layout of a worksite including beacons in accordance with some embodiments.

FIG. 2 is a block diagram illustrating components of a user-wearable electronic device in accordance with some embodiments.

FIGS. 3A-3B are block diagrams illustrating a user-wearable electronic device and an intermediary device in accordance with a first set of embodiments.

FIGS. 3C-3D are block diagrams illustrating a user-wearable electronic device and an intermediary device in accordance with a second set of embodiments.

FIG. 4 is a block diagram illustrating an implementation of a monitoring system in accordance with some embodiments.

FIG. 5 is a block diagram illustrating an implementation of a mobile device in accordance with some embodiments.

FIG. 6A is a block diagram illustrating an implementation of an employee profile database in accordance with some embodiments.

FIG. 6B is a block diagram illustrating an implementation of an employee ADW database in accordance with some embodiments.

FIG. 6C is a block diagram illustrating information included in an employee report and information included in a raw data report, in accordance with some embodiments

FIG. 6D is a block diagram illustrating neural network configurations for particular job categories in accordance with some embodiments.

FIG. 7 is a flow chart illustrating data flow in a user-wearable electronic device, configured to perform ADW monitoring and reporting, in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the terms “employee” and “user” are used interchangeably to describe a person performing one or more specific job-related tasks, and/or used to describe a worker in general. Additionally, as used herein, the term “employer” is used to describe any person in a role that involves monitoring ADWs of employees, including one or more business owners, managers, consultants, and/or researchers.

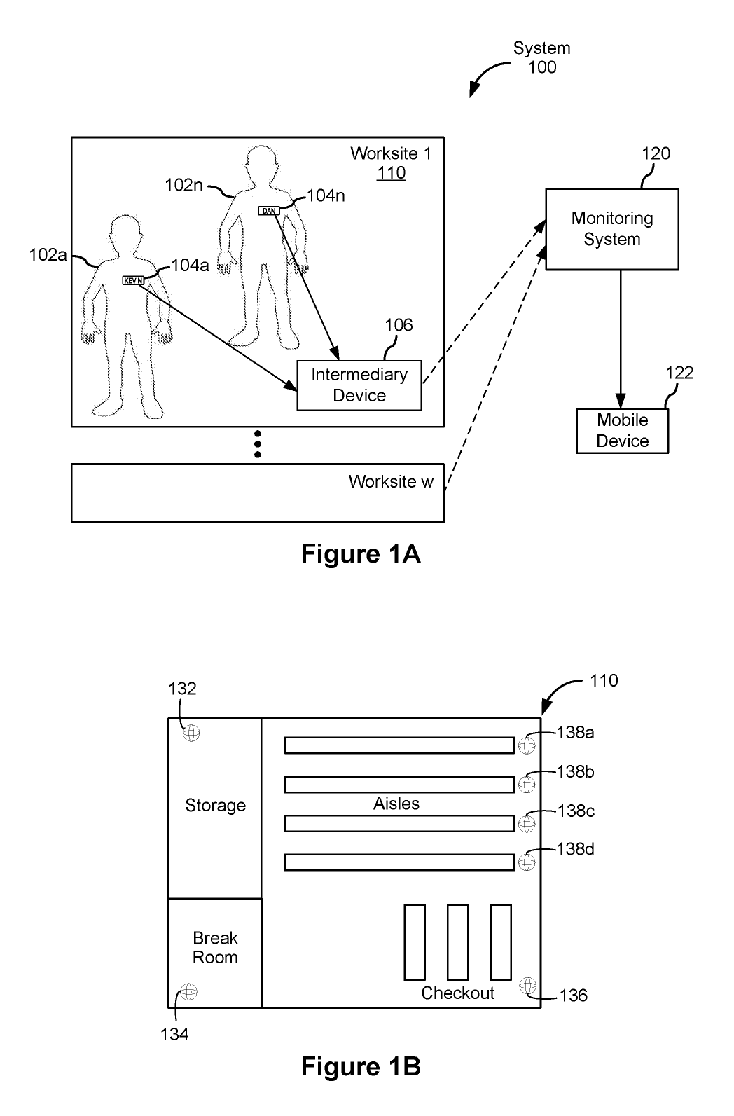

Attention is now directed toward embodiments of activities of daily work (ADW) monitoring and reporting systems in accordance with some embodiments. FIG. 1A is a block diagram illustrating a sample embodiment of an ADW monitoring and reporting system 100. Employees 102a-n, sometimes herein called users, are monitored by user-wearable ADW monitoring devices 104a-n. While FIG. 1A depicts an equal number of employees and monitoring devices, it is appreciated that other configurations, including N employees and M monitoring devices, where N>M, or where N<M, are included in the scope of the various embodiments described herein (with N and M being integers greater than or equal to 1). In some embodiments, an ADW monitoring device 104 is affixed to or embedded in an employee 102's nametag. Optionally, an ADW monitoring device 104 is physically coupled to an employee 102 by way of clothing or any other object that is attached to the employee. In some embodiments, an ADW monitoring device is affixed directly to an employee 102's skin. In some embodiments, ADW monitoring devices 104a-n report ADW data, or ADW identification information generated from the ADW data, to intermediary device 106, which receives the ADW data or ADW identification information and transmits a subset of the data, all of the data, or a representation of the data to monitoring system 120, sometimes herein called a monitoring station. In some embodiments, intermediate device 106 processes ADW data received from ADW monitoring device 104, for example using one or more neural networks, as discussed in more detail below, to produce ADW identification information, and transmits the ADW identification information to a monitoring system, from which authorized users can access the ADW identification information. In some other embodiments, ADW monitoring devices 104a-n directly transmit ADW data or ADW identification information to monitoring system 120.

In some embodiments, employees 102a-n, ADW monitoring devices 104a-n, and intermediary device 106 are located in or at a worksite 110. It is understood that worksite 110 is any arrangement in which an employer may wish to monitor ADWs of one or more employees, including, for example, a store, a storage/stocking/loading/unloading area, a factory, a manufacturing floor, an assembly line, a restaurant, a bar, an outdoor or indoor area for which security is being provided, a delivery vehicle, a garden, a lawn, or a farm. In some embodiments, worksite 110 is one of a plurality of worksites, such as w worksites where w is an integer greater than 1, or greater than 2, which each contain different numbers of employees and ADW monitoring devices, all of which report ADW data (e.g., ADW identification information) to monitoring station 120, either directly or through one or more intermediary devices 106. In other embodiments, worksite 110 is the only worksite from which ADW data is reported to monitoring station 120.

In some embodiments, mobile device 122 is communicatively coupled to monitoring station 120, and provides access to ADW reports for employers wishing to monitor ADW data from one or more employees. In embodiments in which the ADWs of multiple employees are being monitored, mobile device 122 optionally provides access to a desired subset of the employees whose ADWs are being monitored. For example, an employer is optionally given access, via mobile device 122, to the ADW information for a particular subset of employees whose ADW information is being reported to monitoring system 120. Access rights are optionally assigned according to security levels, relevance levels, legal constraints, and/or on a need-to-know basis. For example, a particular store's inventory manager may be given access to ADW reports from truck unloaders and shelf stockers, while the store's customer service manager may be given access to ADW reports from the store's customer service representatives and cashiers. As another example, for embodiments in which monitoring system 120 receives ADW reports from a plurality of different companies, employers may only have access to ADW reports from employees belonging to each employer's respective company. In yet another example, different supervisory employees or managers are given access to ADW information at different levels of granularity. For example, some managers or supervisory employees of an employer may be given access only to summary reports for employees of the employer, for example daily summary reports, without access to more detailed ADW information, while other managers or supervisory employees of the employer have access all ADW information or more detailed ADW information for those employees who they supervise or have responsibility. Optionally or alternatively, for embodiments in which there is no mobile device 122, monitoring station 120 provides access to ADW reports.

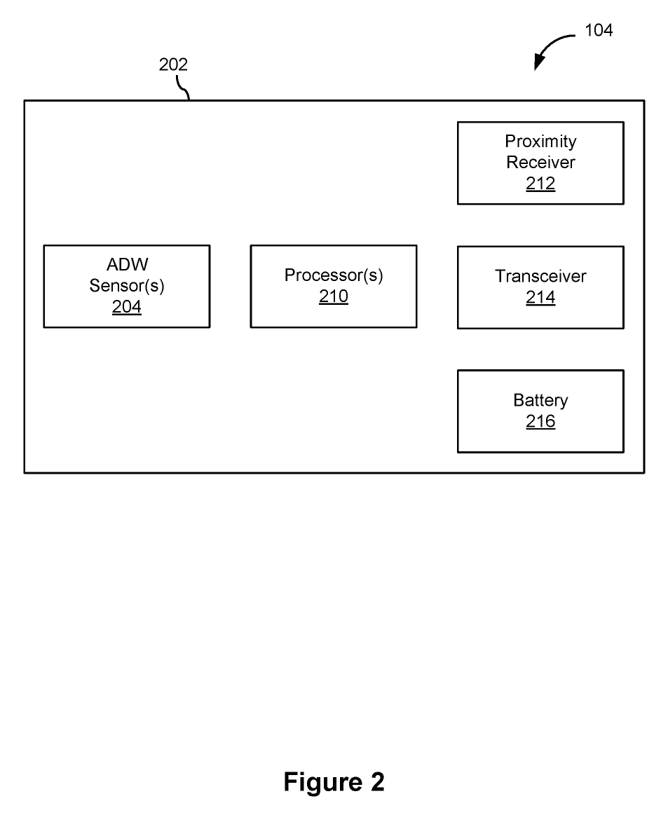

FIG. 1B illustrates an example layout of a worksite 110, which includes four areas in this example. In some embodiments, each area of a plurality of areas of a worksite include a location or proximity beacon 132-138. In some embodiments, only a subset of the areas in a worksite include a location or proximity beacon 132-138. The illustrated placement of beacons 132-138 in FIG. 1B is merely exemplary, and it is understood that placement of each beacon 132-138 in each respective area may depend on factors such as room dimensions, contents, job activity, safety constraints, and the like. Operation of location or proximity beacons 132-138 is discussed below with reference to FIG. 2.

FIG. 2 is a block diagram illustrating components of the user-wearable electronic device 104 (see FIG. 1A), in accordance with some embodiments. User-wearable electronic device 104 includes housing 202, one or more ADW sensors 204, one or more processors 210, proximity receiver 212 (sometimes called a location or proximity sensor), transceiver 214, and battery 216. Transceiver 214 typically includes a transmitter and receiver, with the transmitter being used to transmit employee reports that include ADW information regarding the employee wearing the device, and the receiver being used to receive software and configuration updates, and optionally commands and other information. Battery 216 is typically a rechargeable battery, implemented using any appropriate battery technology. In some embodiments, device 104 optionally includes only a subset of the aforementioned components. For example, in some embodiments, user-wearable electronic device 104 does not include proximity receiver 212.

In some embodiments, housing 202 is configured to be affixed to or embedded in an article of clothing (such as a shirt) or object (such as a nametag) worn by the employee. For embodiments in which device 104 is embedded in an article of clothing or object worn by the employee, housing 202 is partially or completely shared by a housing of the article of clothing or object. For example, for embodiments in which device 104 is embedded in a nametag, housing 202 is a housing for the nametag itself, and the various other components of device 104 are embedded inside the housing for the name tag.

In some embodiments, housing 202 is placed on any portion of the employee's torso that moves with the employee, such as the chest, stomach, back, shoulder, or side of the body. In some embodiments, housing 202 has a compact form factor that allows device 104 to be worn on the employee's body without causing a nuisance to the employee. For example, housing 202 may have a length no greater than 7 centimeters (cm), a height no greater than 3 cm, and a thickness no greater than 0.3 cm. Other dimensions are possible as well, such as a length up to 10 cm and a height up to 7 cm, with a person of ordinary skill in the art recognizing that the bigger the housing, the more of a nuisance its presence may be on the employee's body. However, since a bigger housing can fit more components and/or a larger battery 216, and different dimensions can be optimized to fit various sizes of internal components, the exact dimensions of housing 202 are not meant to be limiting to any of the disclosed embodiments. In some embodiments, housing 202 includes a waterproof or water-resistant seal so that user-wearable electronic device 104 can withstand job activities involving water and worksites having high humidity. In some embodiments, housing 202 and all components within the housing are configured to have a total weight no greater than 120 grams. In other embodiments, the total weight is no greater than 100 grams, 75 grams, 50 grams, or 25 grams.

In some embodiments, ADW sensors 204 include an accelerometer, an orientation sensor, a motion sensor, a gyroscopic sensor, or a combination thereof. In some embodiments, ADW sensors 204 include only one of the aforementioned sensors. ADW sensors 204 generate acceleration data, orientation data, motion data, gyroscopic data, or a combination thereof in response to movements associated with ADWs. In various embodiments, user-wearable electronic device 104 is configured to monitor a subset of p ADWs, where p is 3, 4 or 5, or more generally p is an integer greater than 2, greater than 3, or greater than 4.

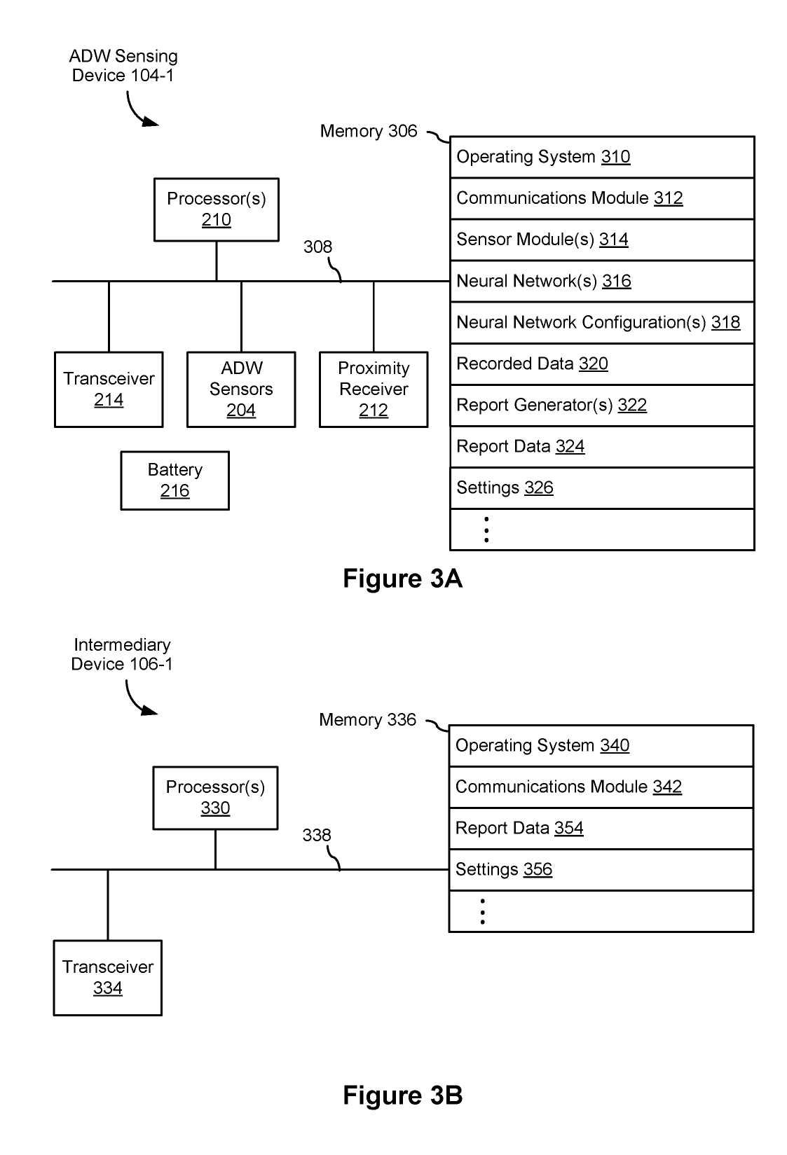

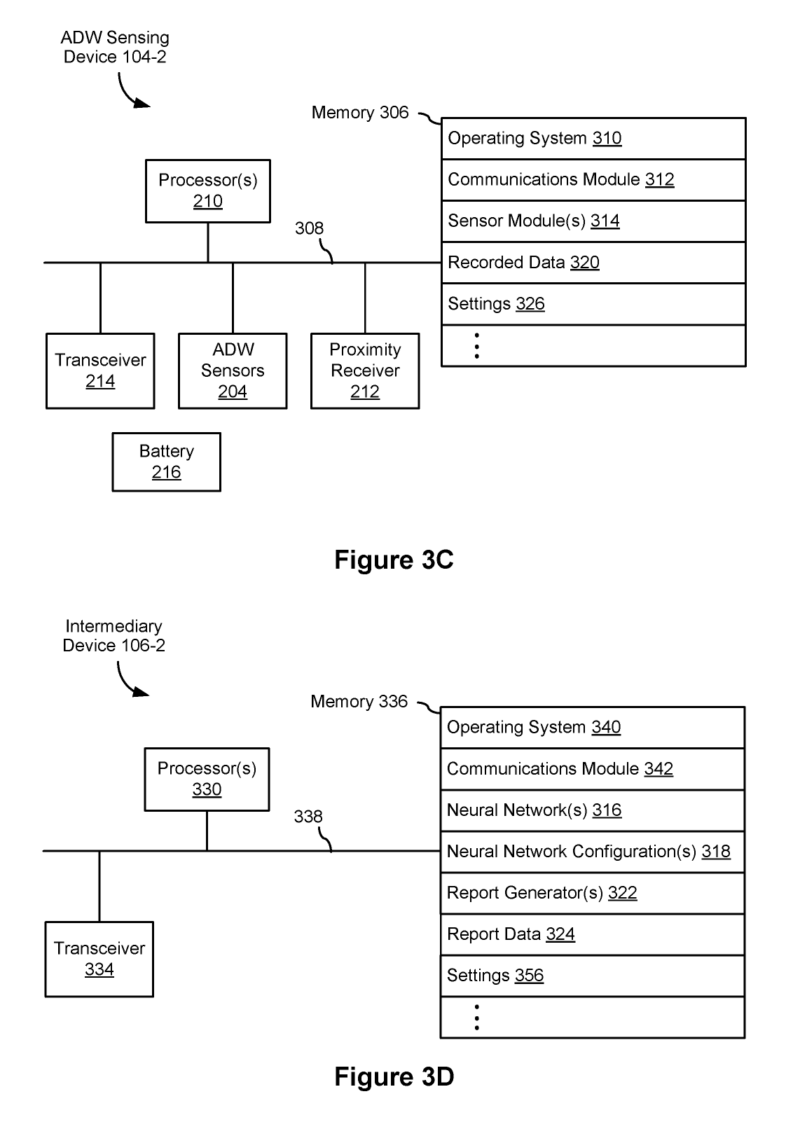

FIG. 3A is a block diagram illustrating a user-wearable electronic device 104-1 in accordance with some embodiments. In some embodiments, device 104-1 includes one or more processors 210, sometimes called CPUs, or hardware processors, or microcontrollers; transceiver 214; ADW sensors 204; memory 306; and one or more communication buses 308 for interconnecting these components. Device 104-1 optionally includes proximity receiver 212. For example, if the system 100 determines an employee's ADWs in part based on the proximity of the employee to one or more beacons, then device 104-1 includes a proximity receiver 212. Communication buses 308 optionally include circuitry (sometimes called a chipset) that interconnects and controls communications between system components.

As explained above with reference to FIG. 2, device 104-1 includes a battery 216. The inclusion of battery 216 in device 104-1 enables operation of device 104-1 as a mobile device, without connection to an external power source (i.e., external to device 104-1). In some embodiments, battery 216 is sized, or has sufficient capacity, to enable operation of device 104-1 for at least one day, or at least two days, or three days, or a week, before the battery requires recharging.

Memory 306 includes high-speed random access memory, such as DRAM, SRAM, DDR RAM or other random access solid state memory devices, and may include non-volatile memory, such as flash memory devices, or other non-volatile solid state storage devices. Memory 306, or alternately the non-volatile memory device(s) within memory 306, comprises a non-transitory computer readable storage medium. In some embodiments, memory 306, or the computer readable storage medium of memory 306 stores the following programs, modules, and data structures, or a subset or superset thereof:
operating system 310, for handling basic computer functions of device 104-1;
communications module 312 used for transmitting ADW data and/or reports via transceiver 214 to monitoring system 120, or an intermediate device 106, or other system; and optionally for receiving updates, instructions and/or other information from one or more external sources, such as monitoring system 120, via transceiver 214;
sensor module(s) 314, sometimes implemented as device drivers, for controlling and/or receiving data from ADW sensors 204 and proximity receiver 212;
one or more neural networks 316, described in more detail elsewhere in this document, for processing raw data from at least one of the ADW sensors 204 so as to determine which activities of daily work the employee wearing the device has been engaged in during each of a sequence of time periods;
neural network configuration(s) 318, which are used to configure the one or more neural networks; the neural network configuration(s) 318 are generated by one or more other systems configured to training one or more similar neural networks using training data, and then included in device 104-1, or transmitted to device 104-1; when the one or more neural networks 316 are configured using neural network configuration(s) 318, the one or more neural networks 316 are pre-trained neural networks;
recorded data 320, which includes recorded raw ADW data from the ADW sensors 204 and optionally proximity information associated with the information received from proximity receiver 212;
one or more report generation modules 322, which generate reports, described in more detail below, for transmission to an intermediary device, a monitoring system, or other system from which ADW information regarding the employee is retrieved;
report data 324, which are the aforementioned reports, or data included in those reports; and
settings 326, typically including a device identifier, optionally including an identifier of the employee wearing the device 104-1, and optionally including settings that enable and disable various features of device 104-1.

Each of the above identified elements may be stored in one or more of the previously mentioned memory devices that together form memory 306. Each of the above mentioned modules or programs, including the aforementioned modules and operating system, corresponds to a set of instructions and data for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 306 may store a subset of the modules and data structures identified above. Furthermore, memory 306 may store additional modules and data structures not described above. In some embodiments, the programs, modules, and data structures stored in memory 306, or the computer readable storage medium of memory 306, provide instructions for implementing respective operations of the methods described herein.

Although FIG. 3A shows an electronic device 104-1, FIG. 3A is intended more as a functional description of the various features which may be present in a user-wearable electronic device, than as a structural schematic of the embodiments described herein. In practice, and as recognized by those of ordinary skill in the art, items shown separately could be combined and some items could be separated.

FIG. 3B is a block diagram illustrating an intermediary device 106-1 in accordance with some embodiments. In some embodiments, device 106-1 includes one or more processors 330, sometimes called CPUs, or hardware processors, or microcontrollers; transceiver 334; memory 336; and one or more communication buses 338 for interconnecting these components. Communication buses 338 optionally include circuitry (sometimes called a chipset) that interconnects and controls communications between system components.

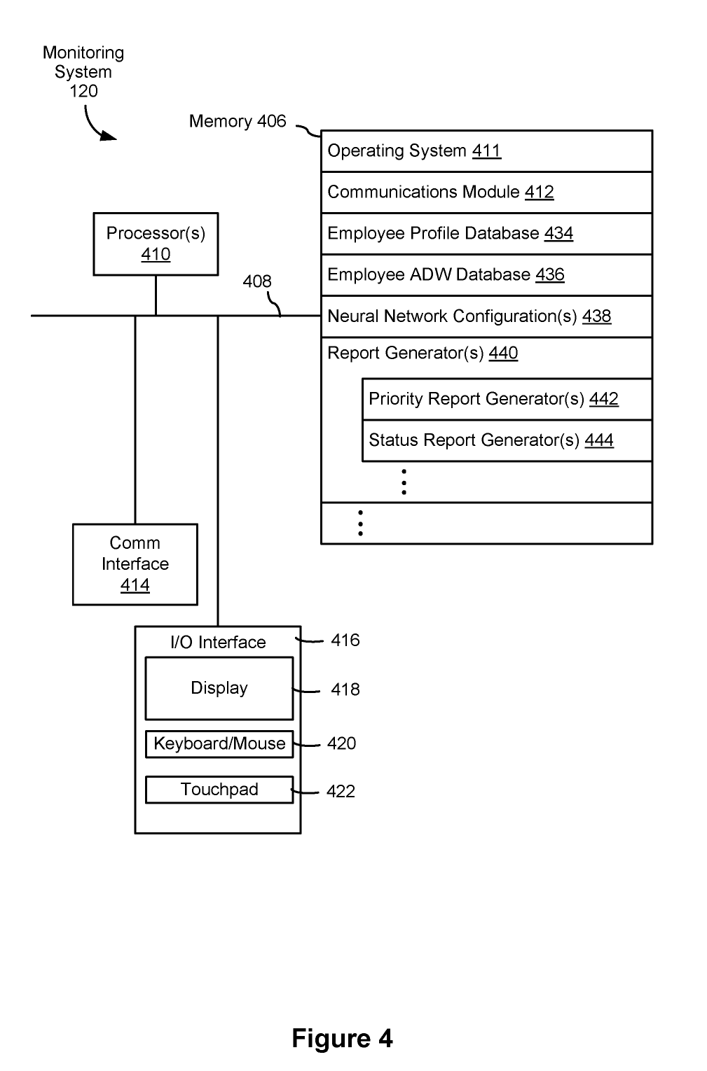

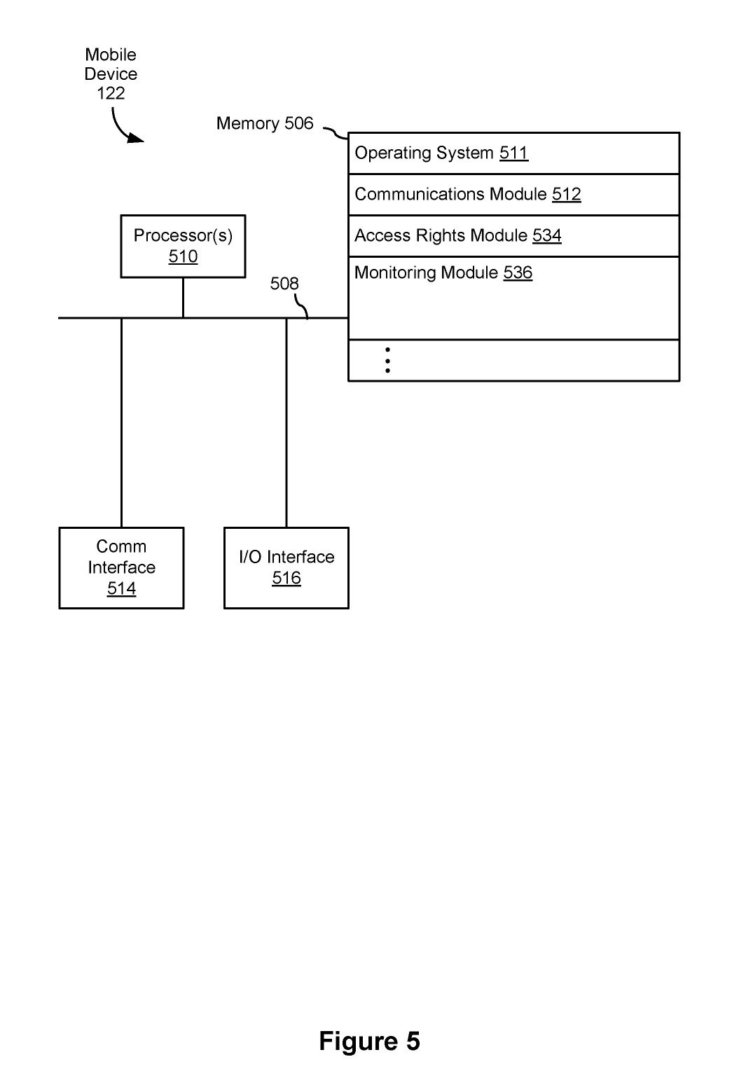

Memory 336 includes high-speed random access memory, such as DRAM, SRAM, DDR RAM or other random access solid state memory devices, and may include non-volatile memory, such as flash memory devices, or other non-volatile solid state storage devices. Memory 336, or alternately the non-volatile memory device(s) within memory 336, comprises a non-transitory computer readable storage medium. In some embodiments, memory 336, or the computer readable storage medium of memory 336 stores the following programs, modules, and data structures, or a subset or superset thereof:
operating system 340, for handling basic computer functions of device 106-1;
communications module 342 used for receiving reports from device 104-1 via transceiver 334; for receiving updates, instructions and optionally other information from monitoring system 120 or other system (i.e., other than intermediary device 106-1 and ADW sensing device 104-1) via transceiver 334; and for forwarding or sending reports or data to monitoring system 120 via transceiver 334;
report data 354, which are reports received from device 104-1, or data included in those reports, which are stored for transmission to a monitoring system (such as system 120, FIG. 4), or other system (such as system 122, FIG. 5) from which ADW information regarding the employee is retrieved by authorized personnel; and
settings 356, typically including a device identifier, and optionally including settings that enable and disable various features of device 106-1.

Each of the above identified elements may be stored in one or more of the previously mentioned memory devices that together form memory 336. Each of the above mentioned modules or programs, including the aforementioned modules and operating system, corresponds to a set of instructions and data for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 336 may store a subset of the modules and data structures identified above. Furthermore, memory 336 may store additional modules and data structures not described above. In some embodiments, the programs, modules, and data structures stored in memory 336, or the computer readable storage medium of memory 336, provide instructions for implementing respective operations of the methods described herein.

Although FIG. 3B shows an electronic device 106-1, FIG. 3B is intended more as a functional description of the various features which may be present in an intermediary electronic device, than as a structural schematic of the embodiments described herein. In practice, and as recognized by those of ordinary skill in the art, items shown separately could be combined and some items could be separated.

In embodiments represented by FIGS. 3A and 3B, ADW sensing device 104-1 processes raw ADW data 320, obtained from one or more ADW sensors 204, using one or more neural networks 316 configured by neural network configuration(s) 318, and generates reports 324 using report generation module(s) 322 for transmission to an intermediary device (e.g., intermediary device 106-1), a monitoring system (e.g., monitoring system 120), or other system from which ADW information regarding the employee is retrieved by authorized personnel.

FIGS. 3C and 3D show another ADW sensing device 104-2 and intermediary device 106-2 in accordance with some embodiments. Features shared with FIGS. 3A and 3B are similarly numbered, and some are not further discussed for purposes of brevity. In these embodiments, the neural network processing modules (316, 318) and report generation module(s) 322 are located (e.g., in memory 336) in intermediary device 106-2. In these embodiments, ADW sensing device 104-2 transmits raw ADW data (e.g., recorded data 320), or data that has been initially or slightly processed to intermediary device 106-2, and intermediary device 106-2 processes the raw ADW data (or slightly processed data) received from ADW sensing device 104-2, using neural networks 316, configured using neural network configuration(s) 318 as described above, and generates reports or report data 324 for monitoring system 120, or other system from which ADW information regarding the employee is retrieved by authorized personnel, using one or more report generation modules 322 as described above.

Each of the above identified elements may be stored in one or more of the previously mentioned memory devices that together form memory 306 (of ADW sensing device 104-2) and/or memory 336 (of intermediary device 106-2). Each of the above mentioned modules or programs, including the aforementioned modules and operating system, corresponds to a set of instructions and data for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 306 and/or memory 336 may store a subset of the modules and data structures identified above. Furthermore, memory 306 and/or memory 336 may store additional modules and data structures not described above. In some embodiments, the programs, modules, and data structures stored in memory 306 and/or memory 336, or the computer readable storage medium of memory 306 and/or memory 336, provide instructions for implementing respective operations of the methods described herein.

As recognized by those of ordinary skill in the art, embodiments corresponding to FIGS. 3A-3B and embodiments corresponding to FIGS. 3C-3D are merely two nonlimiting examples of distributed processing embodiments suitable for generating and processing raw ADW data so as to produce reports or report data having ADW identification information for a respective employee. Stated another way, at least a portion of the neural network processing, at least a portion of the report generation processing, and/or other processing functions described herein are performed solely by processor(s) 210 of the ADW sensing device 104 in some embodiments, performed solely by processor(s) 330 of the intermediary device 106 in some embodiments, or performed by a combination of processors 210 and 330 in some embodiments.

In some embodiments, ADW sensing device 104 carries out all of the processing and transmits reports directly to a monitoring system, or other system from which ADW information regarding the employee is retrieved by authorized personnel, rendering an intermediary device unnecessary. In some embodiments, ADW sensing device 104 carries out all of the neural network processing and computations in real time, but only periodically sends ADW reports (e.g., once an hour, once every 4 hours, or once every 8 hours), or only sends ADW reports when the sensing device 104 is plugged in to a power charger, thereby conserving battery power. In some embodiments, ADW sensing device 104 carries out all of the neural network processing and computations in real time, sends ADW reports periodically, but sends emergency reports in real time. In some embodiments, ADW sensing device 104 carries out all of the neural network processing and computations in real time, and sends the ADW reports in real time (e.g., as soon as a report is ready, such as every minute, every five minutes, every 20 minutes, or every hour). In some embodiments, ADW sensing device 104 carries out neural network processing and computations in real time, and sends ADW reports in real time if the sensing device 104 is in communicative range of an intermediary system 106, a monitoring system 120 or other system from which ADW information regarding the employee is retrieved. Otherwise, if the sensing device 104 is outside of a communication range (e.g., the employee leaves the worksite and the employee's ADW sensing device 104 can no longer wirelessly communicate with the intermediary device 106 or the monitoring system 120), the ADW sensing device 104 continues to sense ADW information and carry out neural network processing, storing ADW reports in local memory (e.g., memory 306) until the sensing device 104 is once again in communication range of an intermediary device 106, monitoring system 120, or other system from which ADW information regarding the employee can be retrieved (e.g., the employee returns to the worksite and the employee's ADW sensing device 104 sends ADW reports stored in memory 306 to the intermediary device 106 or the monitoring system 120).

Although FIGS. 3C-3D show electronic devices 104-2 and 106-2, FIGS. 3C-3D are intended more as a functional description of the various features which may be present in a user-wearable electronic device and an intermediary device, than as structural schematics of the embodiments described herein. In practice, and as recognized by those of ordinary skill in the art, items shown separately could be combined and some items could be separated.

FIG. 4 is a block diagram illustrating an implementation of a monitoring system 120 (see FIG. 1A) in accordance with some embodiments. In some embodiments, monitoring system 120 includes one or more processors 410, sometimes called CPUs, or hardware processors, or microcontrollers; memory 406; one or more communication interfaces 414 (e.g., a transceiver, and/or a network interface); input/output (I/O) interface 416; and one or more communication buses 408 for interconnecting these components. I/O interface 416 typically includes display 418, which is optionally a touch-screen display. I/O interface 416 optionally includes a keyboard and/or mouse (or other pointing device) 420, and optionally includes a touch-sensitive touchpad 422. In some embodiments, monitoring system 120 is implemented as a server that does not include input/output interface 416, and instead client systems such as mobile device 122 (FIGS. 1A and 5) are used by employers to access reports and information stored in monitoring system 120 and to convey commands to monitoring system 120.

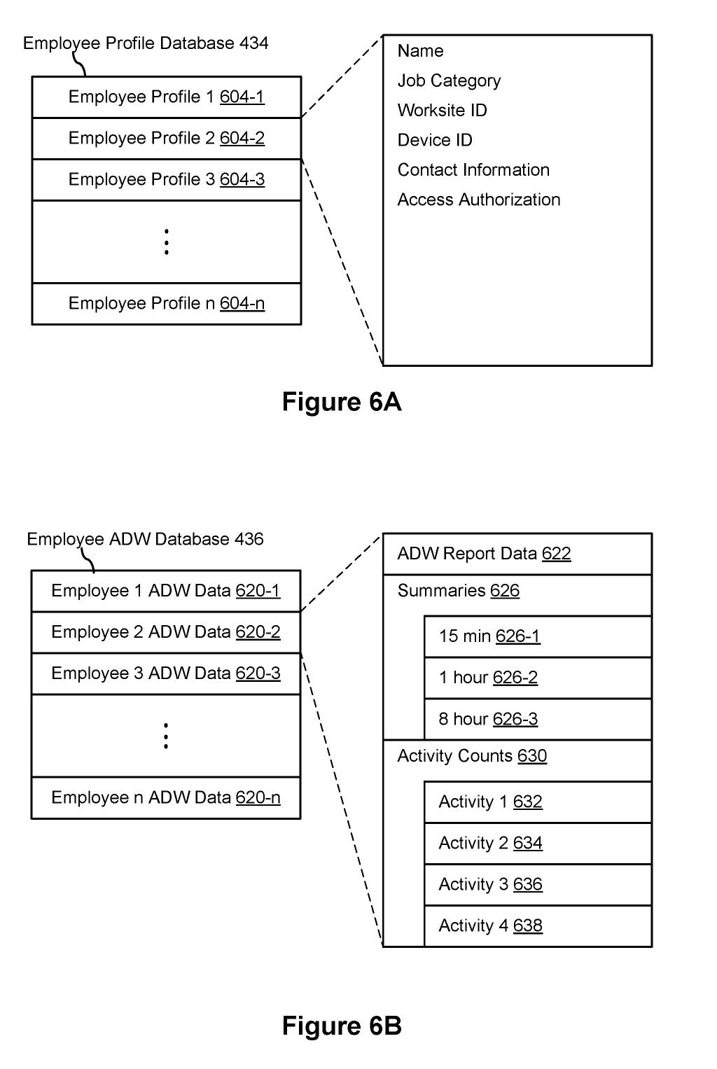

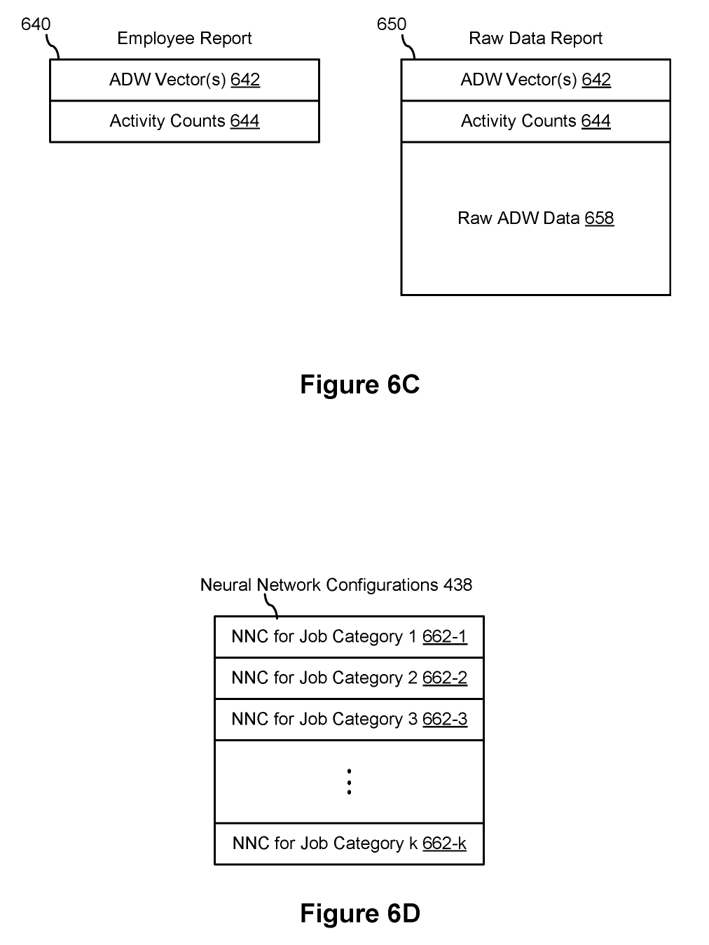

Memory 406 includes high-speed random access memory, such as DRAM, SRAM, DDR RAM or other random access solid state memory devices, and may include non-volatile memory, such as flash memory devices, or other non-volatile solid state storage devices. Memory 406, or alternately the non-volatile memory device(s) within memory 406, comprises a non-transitory computer readable storage medium. In some embodiments, memory 406, or the computer readable storage medium of memory 406 stores the following programs, modules, and data structures, or a subset or superset thereof:
operating system 411, for handling basic computer functions of monitoring system 120;
communications module 412 used for receiving reports and exchanging information with other devices and systems via the one or more communications interfaces 414;
a database or table or other collection of employee profiles 434 of employees for whom monitoring system 120 monitors activities of daily work information;
employee profiles are optionally implemented as or stored in an employee profile database, as shown in FIG. 6A;
employee ADW database 436, which includes ADW information received by monitoring system 120 from one or more user-wearable electronic devices 104 (see FIGS. 1A and 2);
neural network configuration(s) 438, which are used to configure the one or more neural networks in ADW monitoring devices 104, in intermediate devices 106, or in monitoring system 120 itself; the neural network configuration(s) 438 are generated by one or more other systems configured to training one or more similar neural networks using training data, and then stored in memory 406 of monitoring system 120; in embodiment in which neural network processing of raw ADW data is performed by ADW monitoring devices 104 or intermediate device 106, respective neural network configurations 438 are transmitted to such systems;
report generator(s) 440, which generate reports, described in more detail below, such as status reports regarding the monitored employees, and priority reports (e.g., to report emergency situations or job-related violations); in some embodiments report generator(s) 440 include a priority report generator 442, a system report generator 444, and optionally additional report generators.

In some embodiments, memory 406, or the computer readable storage medium of memory 406 also stores one or more neural networks (e.g., similar to neural networks 316, FIG. 3A or 3D, but not shown in FIG. 4), described in more detail elsewhere in this document, for processing raw ADW data from at least one of the ADW sensors 204 so as to determine which activities of daily work the employee wearing the device has been engaged in during each of a sequence of time periods. In such embodiments, raw ADW data from one or more user-wearable ADW sensing devices 104 is transmitted directly or indirection from such devices 104 to monitoring system 120, and monitoring system processes the raw ADW data from each such user-wearable ADW sensing device 104 using one or more neural networks configured to recognize ADWs corresponding to the job or job category of the user of the user-wearable ADW sensing device 104.

Each of the above identified elements may be stored in one or more of the previously mentioned memory devices that together form memory 406. Each of the above mentioned modules or programs, including the aforementioned report generator(s) and operating system, corresponds to a set of instructions and data for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 406 may store a subset of the modules and data structures identified above. Furthermore, memory 406 may store additional modules and data structures not described above. In some embodiments, the programs, modules, and data structures stored in memory 406, or the computer readable storage medium of memory 406, provide instructions for implementing respective operations of the methods described herein.

Although FIG. 4 shows an electronic monitoring system 120, FIG. 4 is intended more as a functional description of the various features which may be present in a monitoring system, than as a structural schematic of the embodiments described herein. In practice, and as recognized by those of ordinary skill in the art, items shown separately could be combined and some items could be separated.

FIG. 5 is a block diagram illustrating an implementation of a mobile device 122 (see FIG. 1A) in accordance with some embodiments. In some embodiments, mobile device 122 includes one or more processors 510, sometimes called CPUs, or hardware processors, or microcontrollers; memory 506; one or more communication interfaces 514 (e.g., a transceiver, and/or a network interface); input/output (I/O) interface 516; and one or more communication buses 508 for interconnecting these components. I/O interface 516 typically includes a display, which is optionally a touch-screen display. For embodiments in which monitoring system 120 (see FIG. 4) is implemented as a server that does not include input/output interface 416, mobile device 122 functions as a client system and is used by employers to access reports and information stored in monitoring system 120 and to convey commands to monitoring system 120. For embodiments in which monitoring system 120 (see FIG. 4) does include input/output interface 416, mobile device 122 functions as an optional, and more mobile, client system that can be used by employers in addition, or in the alternative, to monitoring system 120 to access reports and information stored in monitoring system 120 and to convey commands to monitoring system 120.

Memory 506 includes high-speed random access memory, such as DRAM, SRAM, DDR RAM or other random access solid state memory devices, and may include non-volatile memory, such as flash memory devices, or other non-volatile solid state storage devices. Memory 506, or alternately the non-volatile memory device(s) within memory 506, comprises a non-transitory computer readable storage medium. In some embodiments, memory 506, or the computer readable storage medium of memory 506 stores the following programs, modules, and data structures, or a subset or superset thereof:
operating system 511, for handling basic computer functions of mobile device 122;
communications module 512 used for receiving reports and exchanging information with other devices and systems (e.g., monitoring system 120) via the one or more communications interfaces 514;
access rights module 534 used for determining access rights associated with the employer designated to use the particular mobile device 122; and
monitoring module 536, which facilitates monitoring and review of ADW information by presenting or configuring for presentation (e.g., on a display included in communications interface 514) ADW information and/or reports received from monitoring system 120, corresponding to one or more user-wearable electronic devices 104 (see FIGS. 1A and 2).

Each of the above identified elements may be stored in one or more of the previously mentioned memory devices that together form memory 506. Each of the above mentioned modules or programs, including the aforementioned operating system, corresponds to a set of instructions and data for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 506 may store a subset of the modules and data structures identified above. Furthermore, memory 506 may store additional modules and data structures not described above. In some embodiments, the programs, modules, and data structures stored in memory 506, or the computer readable storage medium of memory 506, provide instructions for implementing respective operations of the methods described herein.

Although FIG. 5 shows an electronic mobile device 122, FIG. 5 is intended more as a functional description of the various features which may be present in a mobile device, than as a structural schematic of the embodiments described herein. In practice, and as recognized by those of ordinary skill in the art, items shown separately could be combined and some items could be separated.

FIG. 6A is a block diagram illustrating an implementation of an employee profile database 434 in accordance with some embodiments. Employee profile database 434 includes a set of employee profiles 604, for example employee profiles 604-1 to 604-n for employees 1 to n. In some embodiments, each employee profile 604 includes the following information, or a subset or superset thereof: the employee's name, job category, an identifier of a worksite at which the employee works (e.g., worksite name, address, or other information identifying the worksite at which the employee works), an identifier of the user-wearable electronic device 104 used by the employee; contact information for the employee or for the worksite; and information identifying which employers or groups of employers are authorized to access the employee's ADW information. In some embodiments, a respective employee profile includes additional information not listed here. For example, in some embodiments an employee may use two user-wearable electronic devices, for example in rotation, with one being worn while the other is recharging, and in such embodiments the employee profile of the employee includes device identifiers for both user-wearable electronic devices used by that employee. In some embodiments, a respective employee profile does not include some of the information items listed here.

FIG. 6B is a block diagram illustrating an implementation of an employee ADW database 436 in accordance with some embodiments. Employee ADW database 436 includes ADW data 620 (e.g., data 620-1 for employee 1, through data 620-n for employee n), which optionally includes other productivity information, for each of a plurality of employees. In some embodiments, the ADW data 620 for each respective employee includes the following information, or a subset or superset thereof:
ADW report data 622, which includes ADW information included in reports received from the electronic device 104 monitoring the employee's ADWs;
summaries 626, which are summaries or digests of the employee's ADW information for various periods of time, such as fifteen minutes (e.g., a summary 626-1 of the employee's ADW information for a period of fifteen minutes, typically the fifteen-minute period immediately preceding the current time), one hour (e.g., a summary 626-2 of the employee's ADW information for a period of one hour, typically the hour immediately preceding the current time, or the last hour worked by the employee), eight hours (e.g., a summary 626-3 of the employee's ADW information for a period of eight hours, typically the eight hours immediately preceding the current time, or the last eight hours worked by the employee), and/or any period of time corresponding to a particular job-specific shift (e.g., a summary of the employee's ADW information over the course of the employee's entire shift); and
activity counts 630 (e.g., a number of times an employee performed a first activity 632, a second activity 634, a third activity 636, a fourth activity 638, any subset of activities, and/or any additional activities).

Examples of activity counts 630 include an ambulation activity count 632, which is or includes, for example, a count of steps by the employee, or a count of minutes in which the employee was ambulating, during one or more predefined period of times, such as fifteen minutes, one hour, and/or eight hours); a lifting activity count 634, which is or includes, for example, a count of times an employee lifted an item onto a shelf, or a count of minutes in which the employee was lifting items onto a shelf during one or more predefined period of times, such as fifteen minutes, one hour, and/or eight hours; a resting activity count 636, which is or includes, for example, a count of minutes in which the employee was resting (e.g., remaining stationary or not performing other ADWs), during one or more predefined period of times, such as fifteen minutes, one hour, and/or eight hours; and/or an interaction activity count 638, which is or includes, for example, a count of customer interactions, or a count of minutes in which the employee was engaged in customer interactions, during one or more predefined period of times, such as fifteen minutes, one hour, and/or eight hours. In the aforementioned examples, each count of the number of instances of an ADW being performed may be considered with a corresponding count of time during which the instances were being performed in order to calculate a productivity value. For example, an employee who lifts S objects onto a shelf in fifteen minutes will have a higher productivity value than an employee who lifts T objects onto a shelf in fifteen minutes, where T is less than S (sometimes represented as T<S).

FIG. 6C is a block diagram illustrating information included in an employee report 640 and information included in a raw data report 650, in accordance with some embodiments. Employee reports 640 and raw data reports 650 are reports generated by a respective user-wearable electronic device 104 and sent to monitoring system 120. In some embodiments, employee reports 640 are generated by device 104 at evenly spaced reporting intervals, such as fifteen minutes, and include information for a corresponding report period. In some embodiments, a respective employee report 640 includes ADW vectors 642 (described in more detail below) for the report period, and activity counts 644 (e.g., activity counts for activities such as ambulating, lifting, resting, and interacting) for the report period.

In some embodiments, user-wearable electronic device 104 generates raw data reports 650 so as to provide monitoring system 120, or one or more other systems, with raw ADW data 658 to enable the generation of improved, or personalized, neural network configurations. In some embodiments, a respective raw data report 650 includes ADW vectors 642 (described in more detail below) for a report period, activity counts 644 (e.g., activity counts for activities such as ambulating, lifting, resting, and interacting) for the report period, and raw ADW data 658 for the report period.

FIG. 6D is a block diagram illustrating neural network configurations 438 in accordance with some embodiments. In some embodiments, user-device 104 is configured to detect job-specific activities which differ according to particular job categories. Accordingly, memory 406 includes neural network configurations (NNCs) 662 programmed for detecting ADWs specific to different job categories (e.g., 662-1 for NNC for job category 1 through 662-k for NNC for job category k). In some embodiments, a job category includes a predefined set of ADWs that includes one or more, two or more, or three or more ADWs specific to the job category, and optionally includes one or more generic ADWs common to multiple job categories.

Exemplary job categories in accordance with some embodiments include, but are not limited to: retail, stocking, customer service, restaurant service, cleaning, manufacturing, security, delivery, healthcare, landscaping, and farming.

Exemplary ADWs specific to a retail job category in accordance with some embodiments include, but are not limited to: operating a cash register, till, or electronic payment device; processing a refund; stocking a shelf; and assisting a customer.

Exemplary ADWs specific to a stocking job category in accordance with some embodiments include, but are not limited to: placing an object onto a shelf or into a specific area; removing an object from a shelf or picking an object out of a specific area; handling, other than said placing and removing, a product or box; and ambulating.

Exemplary ADWs specific to a customer service job category in accordance with some embodiments include, but are not limited to: interacting with a customer; and interacting with a coworker.

Exemplary ADWs specific to a restaurant service job category in accordance with some embodiments include, but are not limited to: serving food, serving a beverage, or delivering a bill; cooking or preparing food; bussing a table; and ambulating.

Exemplary ADWs specific to a cleaning job category in accordance with some embodiments include, but are not limited to: scrubbing, sweeping, dusting, wiping, washing, laundering, and vacuuming.

Exemplary ADWs specific to a manufacturing job category in accordance with some embodiments include, but are not limited to: manufacturing or assembling a specific part of a product; and using a specific tool.

Exemplary ADWs specific to a security job category in accordance with some embodiments include, but are not limited to: actively or inactively patrolling; interacting with one or more other people; and ambulating.

Exemplary ADWs specific to a delivery job category in accordance with some embodiments include, but are not limited to: driving a delivery vehicle; leaving a delivery vehicle; and delivering an item.

Exemplary ADWs specific to a healthcare job category in accordance with some embodiments include, but are not limited to: attending to a patient; performing a specific procedure; washing hands; and charting.

Exemplary ADWs specific to a landscaping job category in accordance with some embodiments include, but are not limited to: operating a vehicle, mowing, raking, shoveling, sweeping, picking, and trimming a lawn or landscape.

Exemplary ADWs specific to a farming job category in accordance with some embodiments include, but are not limited to: operating a vehicle, picking, weeding, crating, washing, and boxing.

Exemplary ADWs specific to any other job category in accordance with some embodiments include, but are not limited to, any activity in general that is related to the job category, or more specifically, any activity related to the job category that involves movement of the employee.

In some embodiments, a generic job category includes generic activities (ADWs) which are common to a plurality of job categories, and includes at least G generic ADWs, where G is an integer greater than one, two, three, or four. Exemplary generic ADWs in accordance with some embodiments include, but are not limited to: operating a vehicle; being transported in a vehicle; ambulating within a defined work space; ambulating outside a defined work space; ambulating; interacting with another person; interacting with a computer or electronic device; and inactivity. In some embodiments, memory 406 initially includes a generic job category NNC, which enables device 104 to be used without a preprogrammed job-specific NNC. In some embodiments, the generic NNC is subsequently updated or replaced with an updated neural network configuration according to a received update or based on subsequent training, resulting in processor(s) 210 reconfiguring or replacing the generic NNC with the updated configuration, thereby enabling job-specific ADW identification information for time periods subsequent to the reconfiguring of the ADW sensing device 104 with a job-specific NNC.

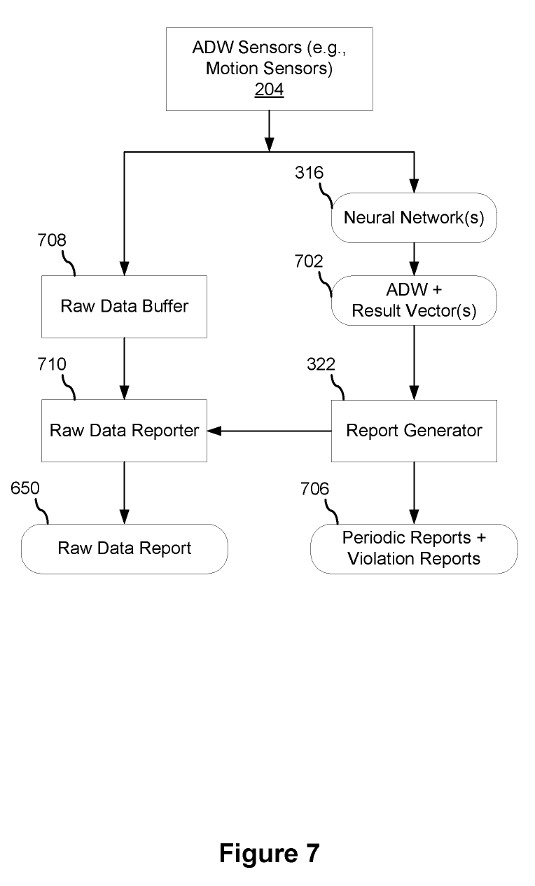

FIG. 7 is a flow chart illustrating data flow in an implementation of a user-wearable electronic device 104, in accordance with some embodiments. As shown, information from one or more ADW sensors 204, for example a motion sensor (e.g., an accelerometer), is provided to one or more pre-trained neural networks 316, which produce one or more result vectors 702 for each report period. For example, in some embodiments, pre-trained neural networks 316 generate a set of result vectors every six seconds, and the result vectors for a report period, such as fifteen minutes are combined or collected by report generator 322, which then produces a digest or other report 706 for each time period, sometimes called a periodic report (e.g., periodic employee reports 640, FIG. 6C) for transmission to monitoring system 120. In some embodiments, reports 706 are transmitted at a predefined time of day or night, at a predefined time relative to a start or end time of a work shift, at a predefined time relative to a work-related event, and/or on demand (e.g., upon request by an employer operating mobile device 122 or monitoring system 120). In some embodiments, the result vectors include information useable to produce activity counts, such as the activity counts discussed elsewhere in this document. In some embodiments, report generator 322 also produces violation reports 706 when the result vectors it receives from neural networks 316 satisfy violation report generation criteria. Examples of violation report generation criteria are discussed below.

In some embodiments, raw ADW sensor data is temporarily stored in a raw data buffer 708 in user-wearable electronic device 104, which, along with the report data included in the aforementioned periodic reports is provided to a raw data report generator 710, which produces a raw data report (e.g., raw data report 650, FIG. 6C) for transmission to monitoring system 120.

Through the use of one or more trained neural networks 316 in user-wearable electronic device 104, ADWs are associated with certain characteristic motions and/or orientations. As a nonlimiting example, lifting is typically associated with a forward-leaning motion or similar torso motion as the employee picks up an object. Similarly, other ADWs are associated with other patterns of movement and/or orientation. One or more neural networks in user-wearable electronic device 104 are trained to recognize motion and/or orientation patterns consistent with lifting, and each of the other ADWs that device 104 is configured to monitor.

In some embodiments, as shown in FIGS. 2 and 3, at least one processor 210 is coupled to the aforementioned sensors, and receives raw sensor data from ADW sensor 204 (hereinafter “raw ADW data”). In some embodiments, processor 210 receives the raw ADW data at a rate of no less than 10 samples per second, in accordance with a sampling period.

For each time period in a sequence of successive time periods, processor 210 generates ADW identification information for the time period by processing the raw ADW data produced by ADW sensor 204 using one or more neural networks pre-trained to recognize a predefined set of ADWs. In some embodiments, the successive time periods each have a duration of no more than 30 seconds (for example, 6 seconds). In some embodiments, processor 210 processes at least 10 samples of raw ADW data for each time period of the successive time periods. Further, in some embodiments, a ratio of the time period (at which processor 210 generates ADW identification information) to the sampling period (at which processor 210 samples raw data) is no less than 100, and is typically between 100 and 5,000. In some embodiments, each pre-trained neural network includes a plurality of neural network layers, and at least one layer of the plurality of neural network layers is, or includes, a recurrent neural network. An output of the neural network for each time period corresponds to the generated ADW identification information for the respective time period.

In some embodiments, processor 210 generates the ADW identification information for a respective time period in the sequence of time periods by generating a set of scores, including one or more scores for each ADW in the predefined set of ADWs. In accordance with the generated set of scores, processor 210 determines a dominant activity for the respective time period, wherein the dominant activity is one of the ADWs in the predefined set of ADWs. In accordance with a determination that the one or more scores for the dominant activity for the respective time period meets predefined criteria, processor 210 includes in the generated ADW identification information for the respective time period information identifying the dominant activity for the respective time period. However, in accordance with a determination that the one or more scores for the dominant activity for the respective time period do not meet the predefined criteria, processor 210 includes in the generated ADW identification information for the respective time period information indicating that the employee's activity during the respective time period has not been classified as any of the ADWs in the predefined set of ADWs. In some embodiments, the predefined set of ADWs includes N distinct ADWs, where N is an integer greater than 2, and the ADW identification information generated by the one or more processors for the time period includes a vector of having at least N+1 elements, only one of which is set to a non-null value. In other embodiments, the predefined set of ADWs includes N distinct ADWs, where N is an integer greater than 2, and the ADW identification information generated by the one or more processors for the time period includes a vector of having at least N elements, only one of which is set to a non-null value.

In some embodiments, proximity receiver 212 is disposed in or on housing 202. Proximity receiver 212 obtains location or proximity information (hereinafter, “raw proximity information”) corresponding to a range or proximity to one or more beacons 132-138 (see FIG. 1B) at known locations in a worksite occupied by the employee, and communicates the raw proximity information to processor 210, which determines location information of the employee based on the raw proximity information. In some embodiments, location information includes an area in which the employee is located (e.g., storage room 132, break room 134, checkout area 136, aisles 138a-d, or any other worksite area). In some embodiments, processor 210 uses the location information to supplement the raw ADW data in order to more accurately generate ADW identification information. For example, by taking advantage of certain location-based ADW assumptions (e.g., an employee interacts with fellow employees, but not customers, in the break room), the one or more neural networks narrow down a subset of possible ADW identification information for a given set of raw ADW data.

In some embodiments, transceiver 214 is disposed in housing 202 and coupled to processor 210. Transceiver 214 obtains ADW identification information for a sequence of time periods from processor 210, and transmits reports for the employee. In some embodiments, transceiver 214 transmits the reports at predefined times at intervals of no less than 5 minutes (for example, fifteen minutes). In other embodiments, transceiver 214 transmits the reports only when device 104 is connected to an external power source or otherwise receiving power from an external power source, for example so as to charge the internal battery 216 of the device. Further, in some embodiments, transceiver 214 transmits the reports in response to a manual transmission command (e.g., by pressing a “transmit” button on device 104, or by an employer requesting the reports while using monitoring station 120 or mobile device 122). In some embodiments, reports are transmitted at a predetermined transmission rate (e.g., every fifteen minutes, every hour, every four hours, every eight hours, and/or once per shift), but with aggregated ADW identification information from a plurality of time periods (e.g., ADW counts for one-minute or five-minute windows of time). It is understood that the aforementioned reporting times and aggregation periods are exemplary, and a person of ordinary skill in the art may configure them to be set in accordance with employer-determined requirements and/or job-specific applications. In some embodiments, a respective report includes ADW information (e.g., a list of ADWs detected during given time periods) corresponding to the generated ADW identification information for one or more time periods in the sequence of time periods.

Further, in some embodiments, in addition to or as an alternative to including ADW identification information, a respective report (e.g., raw data report 650, FIG. 6C) includes raw ADW data that has been stored by processor 210. While processor 210 temporarily stores raw ADW data for one or more time periods, in some embodiments, the raw ADW data is not transmitted to a target system until device 104 is connected to an external power source (e.g., plugged into a power charger), in order to save battery power. Raw ADW data may be transmitted for use in the development of new or improved neural network configurations in order to, for example, identify additional classifications of activity, or improve the classification of raw ADW data into the predefined set of ADWs or other predefined categories. In some embodiments, raw ADW data transmissions for the aforementioned purposes may be prompted by the determination that the one or more scores for the dominant activity for the respective time period do not meet the predefined criteria, as disclosed above. In other words, if raw ADW data cannot be classified as a particular ADW, or the classification has a low confidence score or other indicia of not meeting predefined reliability criteria, processor 210 stores the raw ADW data and transmits it for further analysis. In some embodiments, other data is transmitted along with the raw ADW data (e.g., the ADW identification vector(s), and/or the scores generated using the raw ADW data for the respective time periods).

In some embodiments, processor 210 automatically detects a violation, based on the raw ADW data, in accordance with predefined violation detection criteria. In response to the automatic detection of a violation, processor 210 initiates transmission of a violation report to the target system using transceiver 214. In some embodiments, the criteria for identifying a violation include one or more of: a crossed threshold of time during which an activity has been performed (e.g., or an amount of time longer than an allowed work period between breaks during which ADWs have been detected); a crossed threshold of time during which inactivity has been detected (e.g., an amount of time longer than an allowed break during which no ADWs have been detected); and a crossed threshold of activity counts (e.g., too many or too little ADW events compared to a predefined standard).

In some embodiments, and with reference to FIG. 1A, transceiver 214 wirelessly transmits the reports for the employee to an intermediary device 106, which forwards the reports for the employee to a target system (e.g., monitoring station 120 or mobile device 122). In some embodiments, intermediary device 106 is a power charger for device 104, while in other embodiments, intermediary device 106 is a second instance of device 104 located in the same worksite as the employee (e.g., in the same building as, or otherwise co-located with, the user-wearable electronic device 104). In some embodiments, device 104 is embedded in a nametag, and intermediary device 106 is a nametag docking station which serves as a repository for employees to return their nametags at the end of a shift, where the nametags/devices 104 recharge and transmit data that may not have been otherwise transmitted while being worn by the employees.

In some embodiments, transceiver 214 receives an updated configuration for the one or more neural networks, and sends the updated configuration to processor 210, which reconfigures the one or more neural networks with the updated configuration. As a result, processor 210 thereafter generates ADW identification information for subsequent time periods using the one or more neural networks with the updated configuration. In some embodiments, all of the one or more neural networks are updated with new configurations at the same time. In some embodiments, or in some circumstances, just one of the neural networks is updated with a new configuration, or a subset of the neural networks are updated with new configurations when one or more updated configurations are received by device 104. In some embodiments, the updated configuration allows for more accurate job-specific ADW identification schemes, based on analysis of previously received raw ADW data. In some embodiments, transceiver 214 is a wireless transceiver, while in other embodiments, transceiver 214 is a wired transceiver.

In some embodiments, rechargeable battery 216 is disposed within the housing, and processor 210 performs a predefined set of tasks while device 104 is determined to be connected to an external power source for recharging the battery. In some embodiments, the predefined set of tasks includes transmitting (e.g., through transceiver 214) recorded information that was not transmitted while the system was not connected to the external power source. Further, in some embodiments, the predefined set of tasks includes receiving (e.g., through transceiver 214) update information for reconfiguring at least one aspect of device 104 (e.g., an updated configuration for the one or more neural networks as disclosed above). In some embodiments, device 104 is embedded in a nametag, and a nametag docking station serves as a repository and a charging station, where the nametags/devices 104 recharge and perform one or more tasks of the aforementioned predefined set of tasks.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A user-wearable electronic device, for monitoring user activities of daily work (ADW), comprising:
a housing configured to be worn by or embedded in a device worn by a user;
one or more sensors disposed in the housing, including a first sensor to sense motion of the user and produce raw ADW data;
one or more processors, disposed in the housing and coupled to the one or more sensors, configured to:
for each time period in a sequence of successive time periods,
generate ADW identification information for the time period by processing the raw ADW data produced by the first sensor using one or more neural networks pre-trained to recognize a predefined set of ADWs, the pre-trained one or more neural networks each including a plurality of neural network layers, at least one layer of the plurality of neural network layers comprising a recurrent neural network, wherein an output of the one or more neural networks for each time period corresponds to the generated ADW identification information for the time period; and
a communication interface, disposed in the housing and coupled to at least one of the one or more processors, to transmit one or more reports corresponding to the user, wherein a respective report corresponding to the user includes ADW information corresponding to the generated ADW identification information for one or more time periods in the sequence of time periods.

2. The user-wearable device claim 1, wherein the predefined set of ADWs includes three or more activities of daily work and the generated ADW identification information for a respective time period in the sequence of successive time periods includes classification information identifying a dominant activity for the respective time period, wherein the dominant activity is one of the ADWs in the predefined set of ADWs.

3. The user-wearable device of claim 2, wherein a respective report includes the classification information for a time period corresponding to the respective report in accordance with the identified dominant activity for a corresponding set of the time periods in the sequence of time periods.

4. The user-wearable device of claim 1, wherein the predefined set of ADWs includes three or more activities of daily work and the generated ADW identification information for a respective time period in the sequence of successive time periods includes classification information identifying which, if any, of the ADWs in the predefined set of ADWs are consistent with the raw ADW data produced by the first sensor.

5. The user-wearable device of claim 4, wherein
in accordance with the classification information identifying an ADW which is consistent with the raw ADW data, a respective report includes the classification information identifying the ADW; and
in accordance with the classification information not identifying any ADWs which are consistent with the raw ADW data, a respective report includes an indication of no ADWs for the respective time period.

6. The user-wearable device of claim 1, wherein the predefined set of ADWs includes three or more activities of daily work and the generated ADW identification information for a respective time period in the sequence of successive time periods includes one or more count values associated with one or more of the ADWs in the predefined set of ADWs.

7. The user-wearable device of claim 6, wherein a respective report includes the one or more count values associated with the one or more ADWs.

8. The user-wearable device of claim 1, wherein the respective report further includes raw ADW data sensed during the respective time period.

9. The user-wearable device of claim 1, wherein the predefined set of ADWs includes generic activities which are common to a plurality of job categories, and includes four or more generic activities from the group consisting of:
operating a vehicle;
being transported in a vehicle;
ambulating within a defined work space;
ambulating outside a defined work space;
ambulating;
interacting with another person;
interacting with a computer or electronic device; and
inactivity.

10. The user-wearable device of claim 1, wherein the predefined set of ADWs includes job-specific activities which are specific to a job category selected from the group consisting of:
retail;
stocking;
customer service;
restaurant service;
cleaning;
manufacturing;
security;
delivery;
healthcare;
landscaping; and
farming.

11. The user-wearable device of claim 10, wherein the predefined set of ADWs is specific to the healthcare job category, and includes two or more activities from the group consisting of:
attending to a patient;
performing a specific procedure;
washing hands; and
charting.

12. The user-wearable device of claim 1, wherein the first sensor comprises an accelerometer, an orientation sensor, motion sensor, or gyroscopic sensor.

13. The user-wearable device of claim 1, further comprising a location or proximity sensor disposed in or on the housing;
wherein the one or more processors are further configured to:
determine location information for the user based on data from the location or proximity sensor; and
generate at least a portion of the ADW identification information for the time period by processing the raw ADW data produced by the first sensor and the location information for the user using at least one of the one or more neural networks.

14. The user-wearable device of claim 13, wherein the location or proximity sensor is configured to obtain or generate range or proximity information corresponding to a range or proximity to one or more beacons at known locations in an environment occupied by the user; and wherein at least one processor of the one or more processors is configured to determine the location information for the user based on the range or proximity information.

15. The user-wearable device of claim 1, wherein the one or more processors is configured to generate the ADW identification information for a respective time period in the sequence of time periods by:
generating a set of scores, including one or more scores for each ADW in the predefined set of ADWs;
in accordance with the generated set of scores, determining a dominant activity for the respective time period, wherein the dominant activity is one of the ADWs in the predefined set of ADWs;
in accordance with a determination that the one or more scores for the dominant activity for the respective time period meets predefined criteria, including in the generated ADW identification information for the respective time period information identifying the dominant activity for the respective time period.

16. The user-wearable device of claim 1, wherein the predefined set of ADWs includes N distinct ADWs, where N is an integer greater than 2, and the ADW identification information generated by the one or more processors for the time period includes a vector having at least N elements, only one of which is set to a non-null value.

17. The user-wearable device of claim 1, wherein
the pre-trained one or more neural networks include a first neural network having a first configuration;
the communication interface is configured to receive an updated configuration for the first neural network; and
the one or more processors are further configured to reconfigure the first neural network with the updated configuration, and to thereafter generate ADW identification information for time periods subsequent to the reconfiguring of the first neural network, using the first neural network configured using the updated configuration.

18. The user-wearable device of claim 1, wherein the communication interface comprises a wireless transceiver, the housing has a length no greater than 7 cm, a height no greater than 3 cm, and a thickness of 2-3 mm, and the housing and all components within the housing have a total weight no greater than 120 grams.

19. The user-wearable device of claim 1, wherein the successive time periods each have a duration of no more than 30 seconds, and the predefined times at which the transmitter transmits reports for the user occur at intervals of no less than 5 minutes.

20. The user-wearable device of claim 1, wherein the communication interface is configured to transmit a report at a predefined event selected from the group consisting of:
a detected violation;
a crossed threshold of time during which an activity has been performed;
a crossed threshold of time during which inactivity has been detected;
a crossed threshold of activity counts; and
a powering event during which the user-wearable device is attached to or placed in a vicinity of a power source.

21. The user-wearable device of claim 1, wherein the one or more processors are configured to receive raw ADW data from the first sensor at a rate of no less than 10 samples per second, in accordance with a sampling period, and a ratio of the time period to the sampling period is no less than 100.

22. The user-wearable device of claim 1, further comprising a rechargeable battery disposed within the housing, wherein the one or more processors are further configured to: perform a predefined set of tasks while the user-wearable device is determined to be connected to a power source for recharging the user-wearable device's battery, the predefined set of tasks including transmitting recorded information not transmitted when the user-wearable device is connected to a power source for recharging the user-wearable device's battery, and receiving update information for reconfiguring at least one aspect of the user-wearable device.

23. An activities of daily work (ADW) monitoring system, comprising:
one or more processors, configured to:
collect raw ADW data produced by a first sensor;
for each time period in a sequence of successive time periods, generate ADW identification information for the time period by processing the raw ADW data produced by the first sensor using one or more neural networks pre-trained to recognize a predefined set of ADWs, the pre-trained one or more neural networks each including a plurality of neural network layers, at least one layer of the plurality of neural network layers comprising a recurrent neural network, wherein an output of the one or more neural networks for each time period corresponds to the generated ADW identification information for the time period; and
transmit one or more reports corresponding to the user, wherein a respective report corresponding to the user includes ADW information corresponding to the generated ADW identification information for one or more time periods in the sequence of time periods.

24. The ADW monitoring system of claim 23, wherein
the system includes a user-wearable electronic device and an intermediary device configured to receive raw ADW from the user-wearable electronic device;
the first sensor is disposed in a housing, located in the user-wearable electronic device, the housing configured to be worn by or embedded in a device worn by a user; and
the ADW identification information is generated by one or more processors in the intermediary device using the one or more neural networks pre-trained to recognize a predefined set of ADWs.
